(19) United States
(12) Patent Application Publication
(10) Pub. No.: US 2010/0133837 A1
(43) Pub. Date: Jun. 3, 2010

(54) METHOD FOR ACCUMULATION AND UTILIZATION OF RENEWABLE ENERGY

(75) Inventor: Christian Kjaer, Storvorde (DK)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: I/S Boewind

(21) Appl. No.: 12/449,894

(22) PCT Filed: Feb. 7, 2008
(86) PCT No.: PCT/DK2008/000062

§ 371 Date: Nov. 3, 2009

(30) Foreign Application Priority Data
Mar. 6, 2007 (DK) PA 2007 00338

(51) Int. Cl. H02K 7/18

(52) U.S. Cl. 290/52

(57) ABSTRACT

The invention includes a method for both accumulation and use of renewable energy from sun, wind or waves. The invention is based on that the renewable energy, which powers for example a windmill (1), is used for production of liquid under pressure in a liquid pump (3), which liquid is subsequent used for operating a liquid turbine (9), which produces electrical energy, which can be tapped at a place of consumption or connected to an existing electrical distribution net.. When the windmill (1) produces more energy than is being consumed, the excess energy is collected and accumulated in liquid under pressure in a hydrophore tank (17) manufactured from flexible material such as rubber. In periods where the renewable energy source via e.g. a windmill (1) cannot produce sufficient electrical energy to match the consumption, the hydrophore tank (17) supplies liquid to the liquid turbine (9) for its operation.

The invention relates to a method for utilization of renewable energy extracted from energy sources such as sun, waves or wind including utilization of e.g. windmills where the energy can be accumulated via operation of a liquid pump, which can pump liquid to a hydrophore tank, from which the energy can then be used as required since a liquid turbine can be operated by liquid from the liquid pump and/or liquid from the hydrophore tank.

As a result of the global demand for energy, renewable energy sources such as sun, wind and waves are used in a still increasing extent as replacement for fossil fuels. Besides being a limited resource, fossil fuels also creates an environmental strain for the nature including human beings.

Through the latest decades, e.g. production of power from windmills has become a significant contribution to the energy consumption in many especially industrialized countries.

The mentioned renewable energy sources have, however, the practical limitation that they can only produce energy under given weather conditions.

Windmills can as an example only produce energy within a limited wind speed range, which is why it is attractive to use techniques for accumulation of renewable energy from periods with optimum weather conditions such as wind speed, which can subsequently be used when e.g. the windmills can not produce energy.

From EP 1637733 A1 is known such a technique, where the energy from windmills is accumulated since liquid under pressure is pumped to storage in hydrophore tanks, from which the liquid can subsequently be used to operate a turbine,, e.g. when the weather conditions entail that the windmills do not operate optimally.

It has been found, however, that there are some drawbacks connected to the known technique, including that the used hydrophore tanks are inflexible since they have a fixed volume for accumulation of liquid.

The hydrophore tanks can only accumulate energy by pumping in liquid within a limited liquid pressure range similar to the liquid pump's capacity and the tank's permitted maximum pressure.

The hitherto known hydrophore tanks will therefore, for a given tank and a given liquid pump, only be able to operate efficiently within a relatively small energy interval defined by their fixed volume.

It is therefore an object of the invention to improve the known method for use of renewable energy.

The object of the invention is achieved by a method of the type stated in the introductory portion of claim 1, which is characterized in that the hydrophore tank is manufactured from a bendable materiel such as a polymer including a rubber.

In this way it is Thus made possible to store excess energy, which is produced by e.g. windmills during windy weather, consisting of liquid under pressure, which is accumulated in a hydrophore tank in a significantly larger energy interval than it has hitherto been possible.

Further preferred embodiments of the method of the invention are defined in claims 2 and 3.

The invention will now be explained more fully with reference to the drawings, in which:

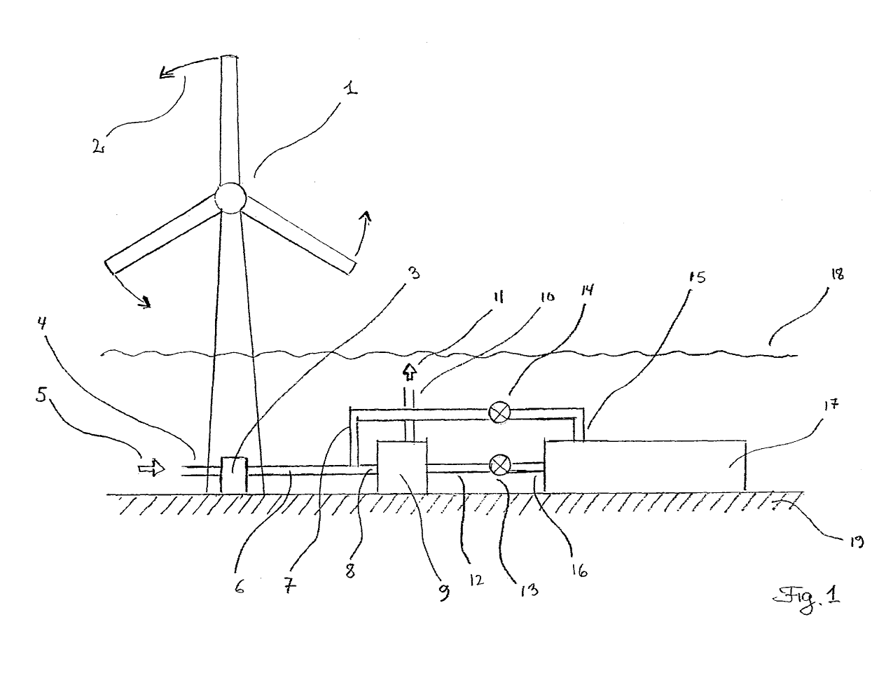

FIG. 1 shows a simplified diagram of a windmill-based facility for utilisation of renewable energy where the energy produced by the mill is used for operating a liquid pump from which the liquid under pressure can be accumulated in a hydrophore tank and/or used for operating a liquid turbine.

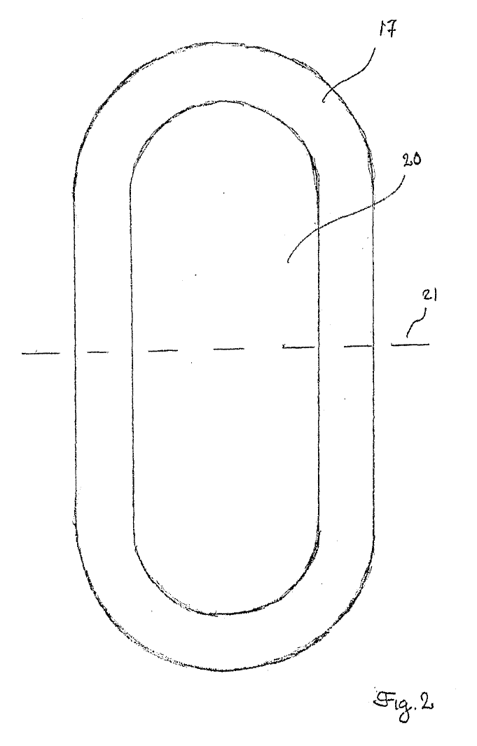

FIG. 2 shows, seen from above, a simplified diagram Of a hydrophore tank.

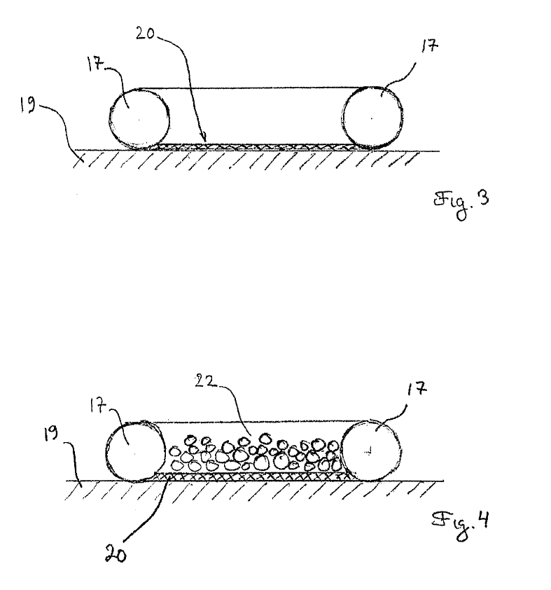

FIG. 3 shows, seen in a cross section, a simplified diagram of the same hydrophore tank, which is shown in FIG. 2.

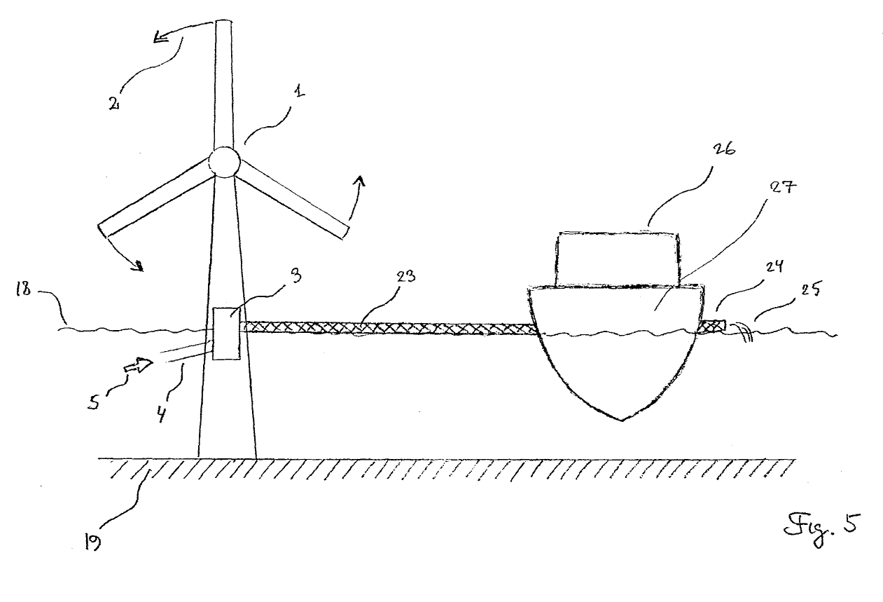

FIG. 4 shows the same simplified diagram as shown in FIG. 3 but where the bottom of the hydrophore tank is filled with stones or similar materials for anchorage.

FIG. 5 shows a simplified diagram of a facility where a worn-out oil tank ship contains both liquid turbine and hydrophore tank and is supplied with liquid under pressure produced by a windmill.

In FIG. 1, the symbol 1 indicates a windmill with three blades, which rotates with a direction of rotation shown with 2.

The windmill is placed in liquid such as water with a surface 18, for example at the bottom 19 of a lake or an ocean with either freshwater or salt water.

The windmill 1 operates a liquid pump 3, for example via a direct mechanical connection between the rotating blades and the pump 3 consisting of a driving gear or a shaft.

The liquid pump 3 is supplied with liquid 5 such as water via an inlet 4.

From the liquid pump 3, liquid under pressure is channeled via an outlet pipe 6 to a liquid turbine 9 from which, via the channeled liquid under pressure, electrical energy can be produced, or to a so-called hydrophore tank 17.

The hydrophore tank 17 is characterized in that it besides the liquid, which is supplied to the tank from the liquid pump 3, also contains an air or gas including preferably atmospheric air.

The hydrophore tank is thus both liquid proof and gas proof and therefore follows the physical laws, which involve pressure and volume of liquids and gasses.

At the, used pressures, which are preferably under 20 atm, the volume of the liquid can be regarded as being constant, while the, gas or air in the tank will react according to the formula, which States that the pressure multiplied with the Volume is constant.

If e.g. the hydrophore tank 17 before it is supplied with liquid from the liquid pump 3, solely contains atmospheric air at a pressure of 1 atm, then both the liquid pressure and the air pressure Will be 2 atm when half of the volume of the hydrophore tank 17 is filled with liquid, 4 atm when three quarters of the tank 17 is filled with liquid etc.

If the liquid pump 3 cant supply a liquid pressure of 20 atm, it thus corresponds to that 95% of the volume of the hydrophore tank can be filled with liquid, whereby the remaining 5% then consists of compressed air or gas.

When it is windy, the windmill 1 thus produces liquid under pressure in the liquid pump 3.

From the liquid pump 3, liquid under pressure is channeled to the liquid turbine 9, which produces electrical energy, which via electric cables can be conducted to a place of consumption or to an existing electrical distribution net.

If the produced energy from the windmill in a specific period exceeds the derived electrical energy from the liquid turbine 9, the surplus energy consisting of liquid under pressure from the liquid pump 3, can via a pipe 7 be channeled to the hydrophore tank 17 where it can be accumulated.

In periods where the windmill can not supply a sufficient amount of energy to match the need for electrical energy from the liquid turbine 9, liquid for operation of the liquid turbine 9 can wholly or partially be taken from the hydrophore tank 17.

Liquid that is channeled to the liquid turbine 9, is discharged after passage of the turbine via an outlet pipe 10.

The pipe connections between the main components of the facility can be provided with valves (13,14) such as electrical or hydraulic powered valves whereby the process can be automated.

An example of a preferred process control is described in the following:

If the liquid pump 3 produces more liquid than there is consumed in the liquid turbine 9, the excess liquid is channeled from the liquid pump 3 to the hydrophore tank 17 via the pipe 7 given that the valve 14 is opened.

This can be carried out until the pressure in the hydrophore tank 17 reaches the, maximum pressure, which can be supplied by the liquid pump 3.

If the liquid pump 3 produces less liquid than what is used via the liquid turbine 9, additional liquid is channeled from the hydrophore tank 17 to the liquid turbine via the pipe 12 by opening of a valve 13.

This can be carried out as long as the pressure in the hydrophore tank 17 exceeds the minimum pressure, Which must be used for operating the liquid turbine 9.

The above mentioned control is thus controlled by operative parameters including:
a) the pressure and flow of liquid from the liquid pump (3)
b) the pressure of the liquid in the hydrophore tank (17) and
c) the energy which is tapped from the liquid turbine (9)

In a preferred embodiment, the process is controlled automatically by a computer controlled control circuit.

Several other forms of control can be used, including controls, which apply check valves so that liquid automatically runs through the network of the facility controlled by the pressures of a specific time in the network including the pipe system and the hydrophore tank.

Tests have shown that it is appropriate in relation to operation efficiency that the main components of the facility such as liquid pump 3, liquid turbine 9 and hydrophore tank 17 are preferably located in the same vertical level, so that the components are effected by the same external pressure from the surroundings.

It will thus be appropriate that the components are located in the same depth of water if they are placed in a lake based or ocean based environment.

Tests have furthermore shown that it creates operational advantages if the outlet 11 of the liquid turbine can be discharged without back pressure Le.

for example in the surface of the water in lake based or ocean based facilities.

FIG. 2 shows, seen from above, a simplified diagram of a preferred version of a hydrophore. tank 17, which in FIG. 3 is shown in a. sectional view, which stems from the sectional line 21 in FIG. 2.

The hydrophore tank 17 is manufactured as a pipe or tube, which includes a Mix of liquid and gas or air, and which encircles as bottom 20, which according to FIG. 4 can be filled with material 22 e.g. rocks or gravel, which can be a naturally occurring bottom material in the lake bottom or ocean bottom where the hydrophore tank 17 is placed.

By using rocks, gravel or other environmentally friendly material 22 to fill in the bottom 20, the advantage is achieved that the hydrophore tank 17 is anchored in a simple, efficient and inexpensive way.

The hydrophore tank 17, as shown in FIG. 2 to FIG. 4, can be manufactured of a polymer including a rubber, which is bendable in order to optimize the Volume flexibility.

It is hereby achieved that the tank can accumulate energy within a remarkably large interval, which is defined by the capacity of the liquid pump, the maximum operational pressure of the tank and the flexibility of the tank.

Practical tests have shown that the energy accumulation interval can thus simply be increased with more than 100% compared to the hitherto. hydrophore tanks with a permanent volume.

In FIG. 5 is shown a simplified diagram where a ship 26 via a preferably flexible pipe 23 is connected to the liquid pump 3, which is operated by a windmill 1.

The ship 26 can with advantage be a worn-out former tanker including an oil tanker, which is modified in such a way that the previous cargo tank 27 of the ship now consists the hydrophore tank of the facility.

The tanker 26 can with advantage also often include the liquid turbine, which produces the electrical energy, which the facility via electric cables from the ship 26 is to supply to a place of consumption or to an existing electrical supply net.

By using worn-out tankers 26 as basis of a hydrophore tank 27, the advantage is achieved that tanks with very large capacities can be acquired for very low costs, whereby the total costs of facilities are minimized.

As shown schematically in FIG. 5, it can be an advantage that the liquid pump 3 is placed vertically at the level of the ship 26, which contains hydrophore tank 27 and the liquid turbine.

The liquid, which powers the liquid turbine, can after use be discharged 25 via an outlet pipe 24.

The ship 26 can besides liquid turbine and hydrophore tank be provided with one or several windmills 1 and liquid pumps 3, whereby the ship 26, e.g. consisting of a worn-out oil tanker physically includes a complete energy facility for use of and accumulation of renewable energy.

It is a part of the invention that, several primary energy converters such as windmills can be connected for operation around the same liquid turbine and/or hydrophore tank.

It is likewise a part of the invention that several different primary energy converters such as windmills and wave power facilities including facilities based on so-called ram technology can be connected for operation with the same liquid turbine arid/or hydrophore tank.

1. A Method for utilization of renewable energy extracted from energy sources such as sun, waves or wind including application of e.g. windmills (1) where the energy can be accumulated via operation of a liquid pump (3), which can pump liquid. to a hydrophore tank (17), from which the energy can then be used as required since a liquid turbine (9) can be operated by liquid from the liquid pump (3) and/or liquid from the hydrophore tank (17) characterized in that the hydrophore tank (17) is manufactured from a bendable material such as a polymer including a rubber.

2. A Method according to claim 1 characterized in that the hydrophore tank (17) is shaped as a pipe, which encircles a bottom (20)

3. A Method according to claim 2 characterized in that the hydrophore tank (17) is anchored on a lake bottom or an ocean bottom by using Material such as sand or rocks from the lake bottom or ocean bottom, Which are piled up on the bottom surface (20)
